(19) United States
(12) Patent Application Publication
(10) Pub. No.: US 2020/0097883 A1
(43) Pub. Date: Mar. 26, 2020

(54) DYNAMICALLY EVOLVING TEXTUAL TAXONOMIES

(71) Applicant: INTERNATIONAL BUSINESS MACHINES CORPORATION, Armonk, NY (US)

(72) Inventors: Fan Jing Meng, Beijing (CN); Xiao Zhang, Shanxi (CN); Peng Fei Chen, Beijing (CN); Lin Yang, Beijing (CN); Jing Min Xu, Beijing (CN); Shi Lei Zhang, Beijing (CN); Naga A. Ayachitula, Elmsford, NY (US); Zhuo Su, Taikoo Shing (HK); Rohit Khandekar, Jersey City, NJ (US)

(21) Appl. No.: 16/142,788

(22) Filed: Sep. 26, 2018

(51) Int. Cl. G06Q 10/06; G06N 99/00; H04L 29/06; G06N 5/02; G06F 17/27

(52) U.S. Cl. CPC G06Q 10/063112; G06N 99/005; G06F 17/2775; G06N 5/022; G06F 17/2785; H04L 63/20

(57) ABSTRACT

Methods and systems for ticket classification and response include clustering tickets according to semantic similarity to form ticket clusters. A template associated with each ticket cluster is determined that includes an invariant portion and a variable portion. A new ticket sub-class, based on the variable portion of the template, is determined that represents a specific sub-type of an existing class. A ticket taxonomy is updated to include the new ticket sub-class. The tickets are labeled according to the updated ticket taxonomy. The tickets are automatically responded to.

### BACKGROUND

### Technical Field

The present invention generally relates to information technology service management and, more particularly, to the automatic update of textual taxonomies based on ticket data.

### Description of the Related Art

As enterprise computing systems and networks grow larger, the difficulty of managing those systems also increases. Information technology management typically employs a system of “tickets” to track actions from initial reporting to resolution, with tickets being generated by a wide variety of sources that include individual hardware devices, software applications, and human users of the system. Tickets are not limited to problems or defects in the system but are often used for more general tracking of events and information.

Thus, as the size of the enterprise system grows larger, with more components being used in more complicated and interrelated ways, the number of tickets to manage also increases. Manual classification of tickets, where a human operator with subject matter expertise identifies a ticket and forwards it to a responsible party, cannot scale appropriately to handle large volumes of tickets. Existing systems for automatic classification are generally unable to respond to new types of ticket that were encountered during training.

Furthermore, the systems used to label classes of tickets depends on domain knowledge from subject matter experts. Manually analyzing large volumes of complex tickets to determine correct labels is a time-consuming process.

### SUMMARY

A method for ticket classification and response includes clustering tickets according to semantic similarity to form ticket clusters. A template associated with each ticket cluster is determined that includes an invariant portion and a variable portion. A new ticket sub-class, based on the variable portion of the template, is determined that represents a specific sub-type of an existing class. A ticket taxonomy is updated to include the new ticket sub-class. The tickets are labeled according to the updated ticket taxonomy. The tickets are automatically responded to.

A ticket classification and response system includes a ticket clustering module configured to cluster tickets according to semantic similarity to form ticket clusters. A template mining module is configured to determine a template associated with each ticket cluster that includes an invariant portion and a variable portion. A taxonomy update module is configured to determine a new ticket sub-class, based on the variable portion of the template, that represents a specific sub-type of an existing class and to update a ticket taxonomy to include the new ticket sub-class. A ticket labeling module is configured to label tickets according to the updated ticket taxonomy. A response module is configured to automatically respond to the tickets.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a ticket handling system that includes ticket generating systems and a ticket classification/response system that processes and responds to the tickets in accordance with an embodiment of the present invention;

FIG. 2 is a block/flow diagram of a method for labeling and responding to tickets in an environment where tickets having a new format arise in accordance with an embodiment of the present invention;

FIG. 3 is a block/flow diagram of a method for automatically updating a ticket labeling taxonomy to identify sub-types of ticket classes in accordance with an embodiment of the present invention;

FIG. 4 is a block/flow diagram of a method for labeling tickets based on updated domain knowledge in an environment where tickets having a new format arise in accordance with an embodiment of the present invention;

FIG. 5 is a block/flow diagram of a method for updating domain knowledge in an environment where tickets having a new format arise in accordance with an embodiment of the present invention;

FIG. 6 is a block diagram of a ticket classification/response system for labeling and responding to tickets in an environment where tickets having a new format arise in accordance with an embodiment of the present invention;

FIG. 7 is a block diagram of a processing system suitable for implementing the ticket classification/response system in accordance with an embodiment of the present invention;

FIG. 8 is a diagram of a cloud computing environment according to the present principles; and

FIG. 9 is a diagram of abstraction model layers according to the present principles.

### DETAILED DESCRIPTION

Embodiments of the present invention provide a ticket classification system that identifies ticket patterns that are similar to existing ticket classes by identifying invariant portions of clustered tickets. The ticket classes are then updated to include sub-categories that have more detail than the original categories. These updated ticket classes are used for ticket classification going forward, providing additional specificity and automatically refining the ticket classification system. Additionally, the tickets can be processed to identify areas that are more variable than others, aiding human subject matter experts in the identification and labeling of ticket classes.

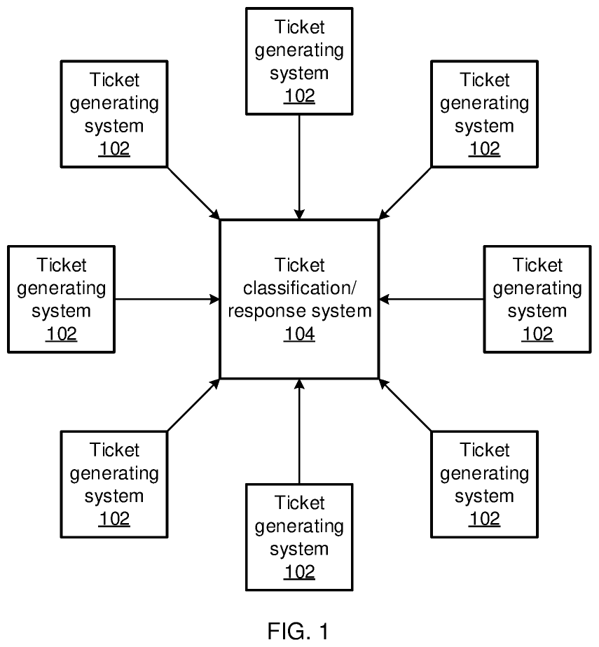

Referring now to the drawings in which like numerals represent the same or similar elements and initially to FIG. 1, an enterprise system is shown that includes a large number of ticket generating systems 102. Each ticket generating system 102 may represent a discrete device, a group of devices, a software component, or a user manually creating a ticket through an interface. Exemplary ticket generating systems include desktop computers, servers (e.g., web servers, database servers, etc.), dedicated devices such as sensors, automatic security systems, network security systems, and any other system that might detect and report an event that necessitates further action. Such events may include, for example, a storage device running out of storage space, a malfunction in a physical system such as a cooling system, a request for implementation of a new feature, a bug report, the unexpected shutdown of a software service, unexpected traffic indicative of an unauthorized intrusion, etc.

These tickets are all sent to a ticket classification/response system 104. In a large enterprise, there may be multiple such systems that operate in a coordinated, decentralized fashion to classify and respond to tickets. The classification/response system 104 labels tickets and then forwards the tickets to an appropriate responder or, in some embodiments, responds to the tickets directly. Thus, the classification/response system 104 may automatically respond to a ticket by an action such as, e.g., changing a system policy or configuration, changing a security policy or configuration, automatically contacting a user with information relevant to their problem, triggering an arbitrary programmed action responsive to the occurrence of a particular condition, escalating a ticket to a human operator's attention, or forwarding a ticket to an appropriate queue for later handling.

It is specifically contemplated that the classification/response system 104 uses machine learning to classify tickets according to known labels and associated patterns. A set of training data is used that may be, e.g., manually classified according to a set of predetermined ticket labels. The classification/response system 104 determines classifiers using an appropriate machine learning process based on the set of training data. However, when tickets of a new variety are detected, the taxonomy needs to be updated to handle the new tickets. This can occur when, for example, a new type of software or system is installed on the network and generates tickets that have not been seen before.

For those tickets that are not readily identified by the existing classifiers, the present embodiments use clustering to group tickets together according to, e.g., semantic similarities. In other embodiments, all tickets are clustered to help identify new sub-classes of tickets. Ticket patterns are extracted from the similar tickets and variable and invariant portions of the ticket patterns are identified. The invariant portion is used to create a new class or sub-class for the tickets that is used to particularly identify the tickets. This process can identify an appropriate label for an unlabeled ticket according to labeled tickets that it has been grouped together with. The process can also identify tickets and groups of tickets that do not match any label and represent a new type or format of ticket. The classification/response system 104 identifies a template for the new type of ticket that can be used for future classification.

It should be understood that the network illustrated in FIG. 1 may be embodied as a number of discrete hardware systems or may, alternatively, be implemented within a single system. In single-system embodiments, the ticket generating systems 102 and the ticket classification/response system 104 may be implemented as different hardware and/or software components that are housed within a single device. In a distributed system, multiple distinct ticket generating systems 102 communicate with the ticket classification/response system 104 via a network or other communication means, including wired and/or wireless communications. The ticket generating systems 102 may be separated by large geographic distances or may be housed together, e.g., within a data center. In some embodiments, ticket handling may be handled in cloud-based implementation, with the ticket classification/response system 104 itself being distributed over multiple different computing systems and physical locations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

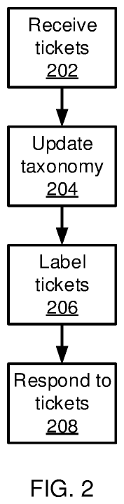

Referring now to FIG. 2, a method for handling tickets in a ticket/classification response system 104 is shown. Block 202 receives the ticket(s) from the ticket generating system(s) 102. It is specifically contemplated that the tickets may be numerous and may be very heterogeneous, being generated by varied systems according to many different formats. It is also contemplated that the ticket formats may change over time as new systems are introduced.

Block 204 updates the classification taxonomy according to the received tickets, particularly when previously unseen tickets are received. It should be understood that the taxonomy may be updated at any time. In some embodiments, the taxonomy will be updated after a predetermined number of tickets have been received. In other embodiments, the taxonomy will be updated periodically according to some schedule. In still other embodiments, the taxonomy will be updated responsive to an instruction from a human operator.

Block 206 labels the tickets according to the taxonomy. The labels may indicate, for example, the content stored within the tickets, the nature of the problem reported by the tickets, a destination for the ticket, etc. These labels may be determined automatically or through domain knowledge provided by subject matter experts. After the tickets have been labeled, block 208 forwards the tickets to an appropriate response system or operator to address the tickets. As noted above, block 208 can automatically respond to a ticket by an action such as, e.g., changing a system policy or configuration, changing a security policy or configuration, automatically contacting a user with information relevant to their problem, triggering an arbitrary programmed action responsive to the occurrence of a particular condition, escalating a ticket to a human operator's attention, or forwarding a ticket to an appropriate queue for later handling.

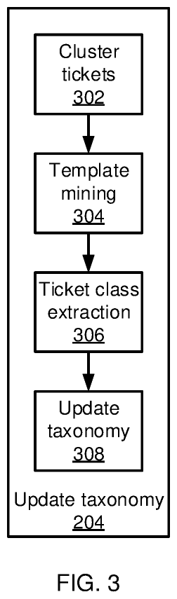

Referring now to FIG. 3, additional detail on the update to the taxonomy in block 204 is shown. Block 302 performs clustering on a set of tickets. The clusters may include received tickets along with a set of historical tickets. It is specifically contemplated that each ticket may be converted to a vector of values in an n-dimensional space. These vectors can then be compared to one another by an appropriate distance metric to find vectors that are close to one another in the n-dimensional space, with any appropriate clustering process being used to identify groups of tickets that are similar to one another. One exemplary clustering process is k-means, but it should be understood that any appropriate clustering process may be used instead.

Block 304 performs template mining on each cluster, determining a characteristic template that represents all of the tickets in a given cluster. Consider, for example, the following three exemplary tickets that have been clustered together:

Job MCDDA9UL (0397581) abended with code 3902. Operation=0023, IA=, APPL=MCDDPC42#000

Job MCDDA9UL (0088481) abended with code 3902. Operation=0023, IA=, APPL=MCDDPC42#000

Job MCDDA9UL (0857622) abended with code 3902. Operation=0023, IA=, APPL=MCDDPC42#000

In this example, the three tickets differ only by the number in parentheses. Thus, one exemplary template to represent this cluster of tickets would be:

Job MCDDA9UL (.*) abended with code 3902. Operation=0023, IA=, APPL=MCDDPC42#000

The invariant portion of the tickets has been retained, but the variable portion has been replaced by an appropriate regular expression, “.*”, which will match any number of characters in its place. More complicated templates may present more complicated patterns, such that different regular expressions would be needed to accurately represent all of the tickets in the cluster. It should be understood that regular expressions are only one way to represent the cluster templates and that any other appropriate expression may be used instead.

Following this example, similar ticket patterns may have different code numbers or other parameters, while maintaining a consistent format otherwise. Thus, a general ticket class may be labeled as, “Job abended.” As new varieties of tickets arrive, creating different sub-types of the general ticket class, block 306 extracts sub-classes that describe the sub-types of ticket. For example, a subtype of the “Job abended” class in view of the above could be, “Job abended—Failed with exit code 3902.” As other tickets with other exit codes arrive, block 306 extracts appropriate sub-classes for the different varieties. Block 308 then updates the taxonomy to include these extracted ticket classes to be used in subsequent ticket labeling.

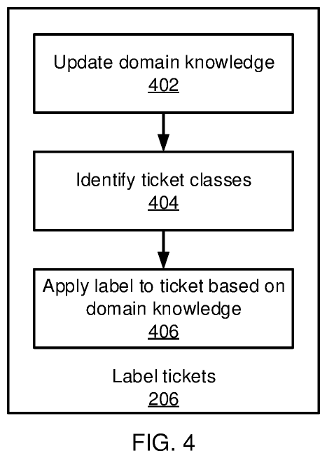

Referring now to FIG. 4, additional detail on the ticket labeling of block 206 is shown. Block 402 updates domain knowledge. The domain knowledge provides information about particular types of tickets and is generally determined by subject matter experts. However, because received tickets can be so voluminous, it can be difficult to manually identify and develop specifications for each new type of ticket. Toward that end, the present embodiments can automatically identify subject matter within ticket patterns that can be used by a subject matter expert to efficiently assign label values to new ticket types.

Based on the accumulated domain knowledge, block 404 identifies one or more classes for the tickets. The class may identify, for example, what kind of situation the ticket represents (e.g., an error, a normal logging event, a bug report, a security intrusion, etc.) and where the ticket should be sent for resolution. The identification of the ticket's class may be performed, for example, using machine-learning classifiers that identify characteristics of the tickets according to known patterns. As noted above, the class may be assigned according to an evolved taxonomy that includes classes and sub-classes for different levels of particularity. Block 406 then labels the tickets according to the identified classes, based on the up-to-date domain knowledge.

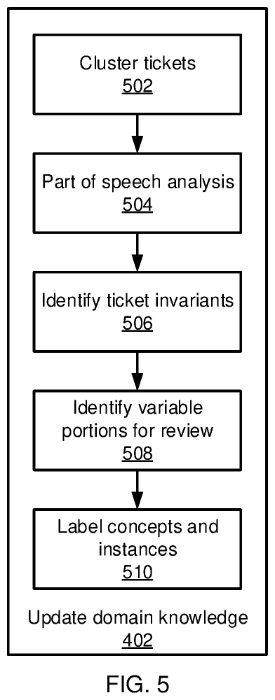

Referring now to FIG. 5, additional detail on updating domain knowledge 402 is shown. Block 502 clusters tickets as described above, for example by representing the tickets as vectors and clustering the vectors according to any appropriate clustering process. Block 504 then performs a part-of-speech analysis that breaks the clustered tickets down into meaningful chunks and tags those chunks. Block 506 then identifies invariants within ticket clusters by comparing which positions within a ticket pattern are consistent through the clustered tickets and which positions have values that differ. The variable portions of the tickets are flagged by block 508 for review by a subject matter expert. In block 510, a subject matter expert identifies the concept represented by the variable portion (e.g., a hostname or error code), with the different values that have been detected representing different instances of the concept. In this manner, the domain knowledge is efficiently expanded to encompass new types of tickets. The subject matter expert can also identify relations between different concepts given two or more concurrent concepts (e.g., hostname and database instance name coexisting within the same group of tickets). This process can be repeated periodically to discover new concepts and/or relations or to retire existing concepts and/or relations as appropriate. These changes are consolidated into existing domain knowledge to keep the domain knowledge up to date.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

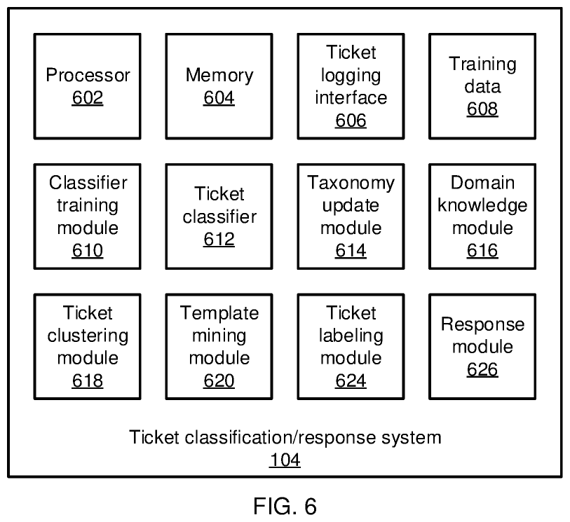

Referring now to FIG. 6, additional detail regarding the structure of the ticket classification/response system 104 is shown. The system 104 includes a hardware processor 602 and memory 604. A ticket logging interface 606 may include a hardware network interface that is configured to receive information from ticket generating systems 102. The ticket generating systems 102 may communicate with the ticket logging interface 606 via a wired or wireless network or, in embodiments where the ticket generating systems 102 and the ticker classification/response system 104 are housed within a single device, via an internal bus or other communications path. The ticket logging interface 606 thus includes a hardware communications interface that is configured to receive tickets from the ticket generating systems 102 and logs those received tickets in memory 604. The memory 604 furthermore includes a set of training data 608 that represents a set of pre-classified tickets.

The ticket classification/response system 104 further includes one or more functional modules that may, in some embodiments, be implemented as software that is stored in memory 604 and is executed by hardware processor 602. In other embodiments, one or more of the functional modules may be implemented in the form of discrete hardware components in the form of, e.g., application-specific integrated chips or field programmable gate arrays.

A classifier training module 610 trains a ticket classifier 612 using the training data 608. Training the ticket classifier 612 may be performed according to any appropriate machine learning process, using a first portion of the training data 608 to train the ticket classifier 612 and a second portion of the training data 608 to perform verification and correction of the ticket classifier 612. A content extraction training module 614 trains a content extraction model that identifies characteristics of tickets based on, e.g., keywords and other content.

The ticket classifier 612 is used by ticket labeling module 624 to classify tickets and to apply a label according to a ticket taxonomy. The ticket classifier 612 assigns labels to the tickets with an associated confidence value. If the ticket labeling module 624 finds the confidence value of a particular label to exceed a threshold value, the label is stored in memory 604.

A taxonomy update module 614 updates and evolves the taxonomy used to label tickets in accordance with new ticket information that is received. A ticket clustering module 616 identifies similarities between tickets, including previously labeled tickets and the training data 608. Ticket clustering module 616 can, for example, represent the tickets as vectors in an n-dimensional space and cluster the tickets within that space using any appropriate clustering process. Template mining module 618 then identifies templates of the ticket clusters that each represent invariant characteristics shared by the tickets in a given cluster. The clustered tickets are used to identify invariant portions in the ticket templates, with distinctions among similar ticket templates representing a potential hierarchical relationship between ticket classes. The taxonomy update module 614 creates new sub-classes when related ticket clusters are found to differ at one or more points.

A domain knowledge update module 616 also uses ticket clustering module 618 and template mining module 620 to identify invariant portions of clustered tickets. The remaining variable portions of the tickets are flagged for review by a subject matter expert, who identifies concepts and instances of those concepts, thereby expanding the domain knowledge base.

A response module 626 performs some appropriate response to labeled tickets. The response may include automatically addressing the ticket by, e.g., automatically acting to resolve the ticket, responding to a person issuing the ticket, forwarding the ticket to a human operator for resolution, or a combination of these, depending on the nature of the ticket.

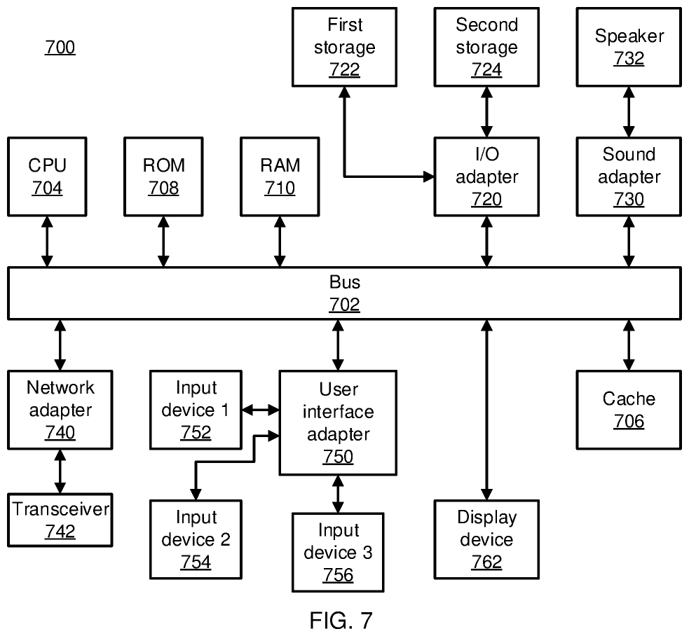

Referring now to FIG. 7, an exemplary processing system 700 is shown which may represent the ticket classification/response system 104. The processing system 700 includes at least one processor (CPU) 704 operatively coupled to other components via a system bus 702. A cache 706, a Read Only Memory (ROM) 708, a Random Access Memory (RAM) 710, an input/output (I/O) adapter 720, a sound adapter 730, a network adapter 740, a user interface adapter 750, and a display adapter 760, are operatively coupled to the system bus 702.

A first storage device 722 and a second storage device 724 are operatively coupled to system bus 702 by the I/O adapter 720. The storage devices 722 and 724 can be any of a disk storage device (e.g., a magnetic or optical disk storage device), a solid state magnetic device, and so forth. The storage devices 722 and 724 can be the same type of storage device or different types of storage devices.

A speaker 732 is operatively coupled to system bus 702 by the sound adapter 730. A transceiver 742 is operatively coupled to system bus 702 by network adapter 740. A display device 762 is operatively coupled to system bus 702 by display adapter 760.

A first user input device 752, a second user input device 754, and a third user input device 756 are operatively coupled to system bus 702 by user interface adapter 750. The user input devices 752, 754, and 756 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 752, 754, and 756 can be the same type of user input device or different types of user input devices. The user input devices 752, 754, and 756 are used to input and output information to and from system 700.

Of course, the processing system 700 may also include other elements (not shown), as readily contemplated by one of skill in the art, as well as omit certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 700 are readily contemplated by one of ordinary skill in the art given the teachings of the present principles provided herein.

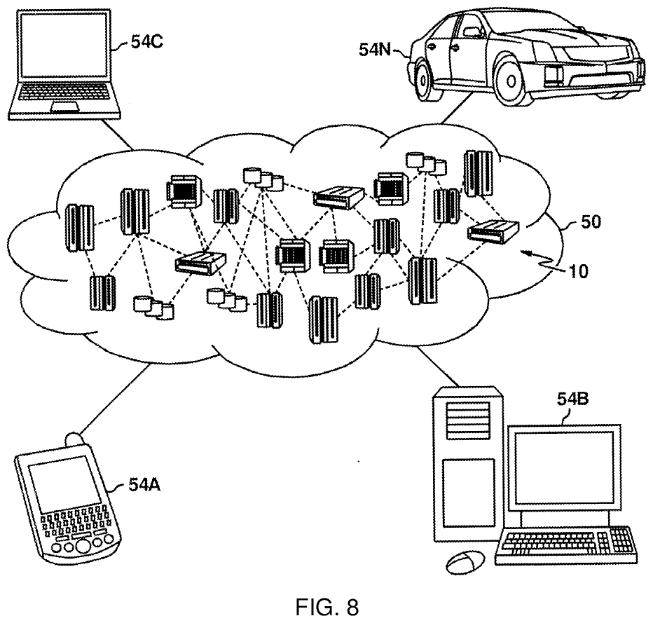

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. are intended to be illustrative only and that computing nodes 10 and cloud computing environment 50 can communicate with any type of computerized device over any type of network and/or network addressable connection (e.g., using a web browser).

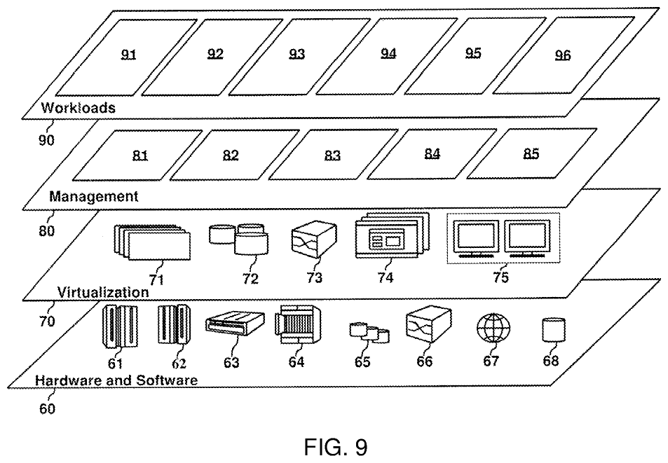

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ticket classification and response 96.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for ticket classification and response, comprising:
clustering a plurality of tickets according to semantic similarity to form a plurality of ticket clusters;
determining a template associated with each ticket cluster that includes an invariant portion and a variable portion;
determining a new ticket sub-class, based on the variable portion of the template, that represents a specific sub-type of an existing class;
updating a ticket taxonomy to include the new ticket sub-class;
labeling the plurality of tickets according to the updated ticket taxonomy; and
automatically responding to the tickets.

2. The computer-implemented method of claim 1, wherein clustering the plurality of tickets comprises representing each of the plurality of tickets as a vector in an n-dimensional space and clustering the vectors.

3. The computer-implemented method of claim 1, wherein the invariant portion is a portion that has identical content across all tickets within a cluster.

4. The computer-implemented method of claim 1, wherein automatically responding to the tickets comprises an action selected from the group consisting of changing a system policy or configuration, changing a security policy or configuration, automatically contacting a user with information relevant to their problem, triggering an arbitrary programmed action responsive to the occurrence of a particular condition, escalating a ticket to a human operator's attention, or forwarding a ticket to an appropriate queue for later handling.

5. The computer-implemented method of claim 1, further comprising flagging the variable portion of the template for review by a subject matter expert.

6. The computer-implemented method of claim 5, further comprising updating a ticket knowledge base to include concepts identified by the subject matter expert as relating to the flagged variable portion.

7. The computer-implemented method of claim 6, wherein updating the ticket knowledge base further includes relations between concepts that co-occur within tickets.

8. The computer-implemented method of claim 6, wherein labeling the ticket is further performed based on the updated ticket knowledge base.

9. The computer-implemented method of claim 5, wherein determining the template comprises performing a part-of-speech analysis on the clustered tickets.

10. A non-transitory computer readable storage medium comprising a computer readable program for ticket classification and response, wherein the computer readable program when executed on a computer causes the computer to perform the steps of:
clustering a plurality of tickets according to semantic similarity to form a plurality of ticket clusters;
determining a template associated with each ticket cluster that includes an invariant portion and a variable portion;
determining a new ticket sub-class, based on the variable portion of the template, that represents a specific sub-type of an existing class;
updating a ticket taxonomy to include the new ticket sub-class;
labeling the plurality of tickets according to the updated ticket taxonomy; and
automatically responding to the tickets.

11. A ticket classification and response system, comprising:
a ticket clustering module configured to cluster a plurality of tickets according to semantic similarity to form a plurality of ticket clusters;
a template mining module configured to determine a template associated with each ticket cluster that includes an invariant portion and a variable portion;
a taxonomy update module configured to determine a new ticket sub-class, based on the variable portion of the template, that represents a specific sub-type of an existing class and to update a ticket taxonomy to include the new ticket sub-class;
a ticket labeling module configured to label the plurality of tickets according to the updated ticket taxonomy; and
a response module configured to automatically respond to the tickets.

12. The system of claim 11, wherein the ticket clustering module is further configured to represent each of the plurality of tickets as a vector in an n-dimensional space and clustering the vectors.

13. The system of claim 11, wherein the invariant portion is a portion that has identical content across all tickets within a cluster.

14. The system of claim 11, wherein the response module is further configured to perform an action selected from the group consisting of changing a system policy or configuration, changing a security policy or configuration, automatically contacting a user with information relevant to their problem, triggering an arbitrary programmed action responsive to the occurrence of a particular condition, escalating a ticket to a human operator's attention, or forwarding a ticket to an appropriate queue for later handling.

15. The system of claim 11, further comprising a domain knowledge module configured to flag the variable portion of the template for review by a subject matter expert.

16. The system of claim 15, wherein the domain knowledge module is further configured to further comprising update a ticket knowledge base to include concepts identified by the subject matter expert as relating to the flagged variable portion.

17. The system of claim 16, wherein the domain knowledge module is further configured to update the ticket knowledge base with relations between concepts that co-occur within tickets.

18. The system of claim 16, wherein the ticket labeling module is further configured to label the plurality of tickets based on the updated ticket knowledge base.

19. The system of claim 15, wherein the template mining module is further configured to perform a part-of-speech analysis on the clustered tickets.
